(19) United States
(12) Patent Application Publication
(10) Pub. No.: US 2005/0286168 A1
(43) Pub. Date: Dec. 29, 2005

(54) Drive unit and manufacturing method thereof

(75) Inventors: YiuSing Ho, Hong Kong (CN); GuoHong Lu, DongGuan (CN); CanHua Chen, DongGuan (CN); Yi Wan, DongGuan (CN)

Correspondence Address: OLIFF & BERRIDGE, PLC, P.O. BOX 19928, ALEXANDRIA, VA, 22320, US

(73) Assignee: SAE Magnetics (H.K.) Ltd., Hong Kong (CN)

(21) Appl. No.: 10/876,536

(22) Filed: Jun. 28, 2004

(51) Int. Cl. G11B 17/02

(52) U.S. Cl. 360/99.12

(57) ABSTRACT

A disk drive unit of the present invention includes a disk, a spindle motor, and an adhesive for fixing the disk to the spindle motor. The adhesive is disposed on a connecting portion between the spindle motor and the disk. The adhesive is thermoset resin or light curing resin or pressure sensitive adhesive. Also, the adhesive can be a liquid adhesive or a solid adhesive. This invention also discloses a method forming such a disk drive unit.

### FIELD OF THE INVENTION

The present invention relates to disk drive units and a method of manufacturing such disk drive units.

### BACKGROUND OF THE INVENTION

Disk drives are information storage devices that use magnetic media to store data. Referring to FIGS. 1(a) and 1(b), a typical disk drive unit 100 in related art comprises a head stack assembly (HSA) 5 with a slider (not shown) and a magnetic disk 2. The magnetic disk 2 is mounted on a spindle motor 31 (also referring as a hub 31) which causes the magnetic disk 2 to spin and a voice-coil motor (VCM) (not shown) is provided for controlling the motion of the HSA 5 and thus controlling the slider thereon to move from track to track across the surface of the magnetic disk 2 to read data from or write data to the magnetic disk 2.

Referring to FIGS. 1(a) and 1(b), a spindle motor assembly 3 of the related art comprises a clamp 32, a screw 33 and the hub 31 mounted on a motor base assembly 1. The hub 31 has a screw hole 20 formed in the center area thereof for receiving the screw 33. The clamp 32 also has a screw hole 10 and an annular flange 80 used for retaining the magnetic disk 2. The magnetic disk 2 with a central hole 40 is sandwiched between the hub 31 and the clamp 32. In addition, the screw 33 extends through the screw hole 10, the central hole 40 and the screw hole 20 to fix the magnetic disk 2 to the hub 31.

In the related art, referring to FIGS. 1(b) and 2, during assembly, the magnetic disk 2 is mounted on the hub 31 by making the hub 31 extend through the central hole 40 thereof. Then, the clamp 32 is mounted on the magnetic disk 2 with the annular flange 80 thereof pressing the magnetic disk 2 because the diameter of the clamp 32 is larger than that of the central hole 40.

However, because the clamp 32 is generally made of rigid material, such as stainless steel, the inner diameter area of the magnetic disk 2 is thus easily deformed under the pressure of the rigid annular flange 80 of the clamp 32. As is known to all, any deformation or distortion of the magnetic disk 2 may alter the recorded signals stored therein. Also, it is difficult to control the uniformity of the pressing force in axial direction exerted to the inner diameter area of the magnetic disk 2 by the clamp 32. This will influence the quality of the signals communicating to the slider on the HSA 5.

In addition, because the annular flange 80 of the clamp 32 presses on the magnetic disk 2 so as to occupy a part of disk data zone of the magnetic disk 2 and thus reduce the capacity of the magnetic disk 2. Furthermore, because the related art utilizes the screw 33 and the clamp 32 to fix the magnetic disk 2 on the hub 31 (spindle motor), it is difficult to guarantee the magnetic disk 2 concentric with the hub 31 (spindle motor) for unavoidable tolerance. Also, the screw 33 and the clamp 32 will increase the thickness of the disk drive unit 100 in Z direction. Finally, manufacturing and assembling the clamp 32 and the screw 33 also takes time and money, accordingly, the manufacturing difficulty and the cost of the disk drives increase.

It is therefore desirable to provide an improved disk drive unit and its manufacturing method to solve the above-mentioned problems.

### SUMMARY OF THE INVENTION

A main feature of the present invention is to provide a low-cost disk drive unit having a larger data capacity, a better signal quality and a thinner thickness.

Another feature of the present invention is to provide a low-cost method of manufacturing disk drive unit which makes little or no disk data zone being occupied, gets a better disk flatness, and reduces the thickness of the disk drive unit.

To achieve the above-mentioned features, a disk drive unit of the present invention comprises a disk, a spindle motor; and an adhesive for fixing the disk to the spindle motor. The adhesive is disposed on a connecting portion between the spindle motor and the disk. The adhesive is thermoset resin or light curing resin or pressure sensitive adhesive. In a preferred embodiment of the present invention, the adhesive is epoxy glue. In the present invention, the disk has a means for enlarging contact area of the disk with the adhesive. In an embodiment, the mean is a taper formed on the connection portion of the disk.

A method of manufacturing a disk drive unit of the present invention, comprises the steps of: providing a spindle motor; providing a disk on a predetermined position; and dispensing an adhesive to a connection portion between the disk and the spindle motor. The adhesive is thermoset resin or light curing resin or pressure sensitive adhesive. In an embodiment, the method further comprises a step of forming a taper on the connecting portion of the disk. In the present invention, the adhesive can be solid adhesive, and accordingly a method of manufacturing a disk drive unit comprises the steps of: providing a spindle motor; providing a disk on a predetermined position; and providing a solid adhesive to a connecting portion between the disk and spindle motor. In an embodiment of the present invention, the method further comprises a step of curing the solid adhesive. The adhesive is thermoset resin or light curing resin or pressure sensitive adhesive. The method further comprises a step of forming a taper on the connecting portion of the disk.

Because the present invention utilizes the adhesive to bond the magnetic disk to the spindle motor instead of using the traditional clamp and the screw so that the magnetic disk is easily concentric with the spindle motor. In addition, because the disk drive unit of the present invention omits the clamp and the screw, the thickness of the disk drive unit is thus reduced. Furthermore, if the present invention uses a solid adhesive to bond the magnetic disk to the spindle motor, it not only makes the bonding process easier than that of using a liquid adhesive, but also avoids contaminating the components of the disk drive unit. Finally, the present invention lowers the cost of manufacturing the disk drive unit for no additional clamp and screw need to be manufactured.

In addition, the adhesive part occupies little, or no disk data zone comparing with the traditional clamp, so it may provide more data tracks on the magnetic disk to increase the data capacity thereof. Finally, because the adhesive part made of the adhesive is rather flexible, so the magnetic disk gets a better disk flatness and a better uniformity of the pressing force in axial direction exerted to the inside diameter area of the magnetic disk, thus a better signal quality can be attained by the disk drive unit of the present invention.

Other objects, advantages and novel features of the invention will become more apparent from the following detailed description of a preferred embodiment thereof when taken in conjunction with the accompanying drawings, wherein:

### DESCRIPTION OF THE DRAWINGS

FIG. 1(a) is a perspective view of a traditional disk drive unit;

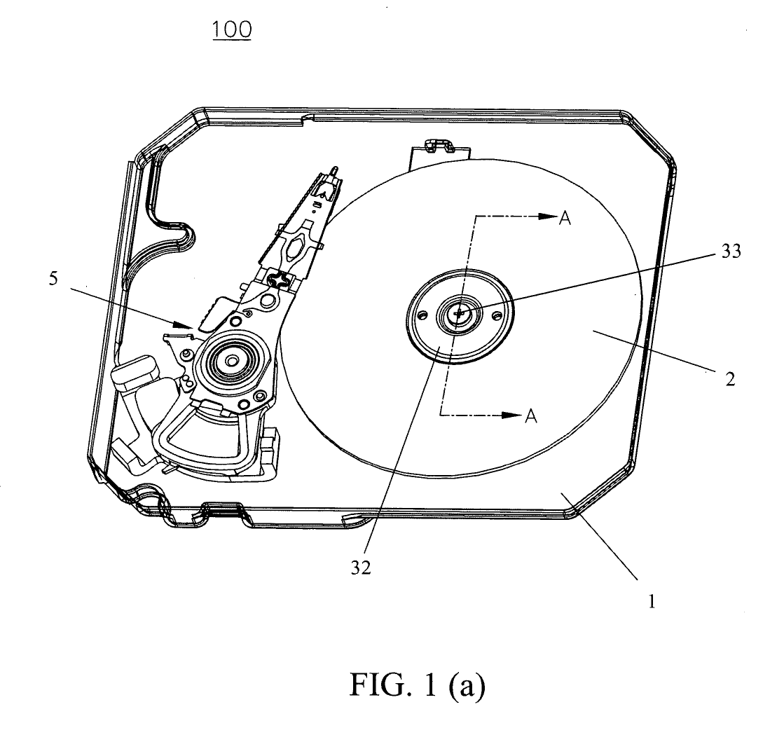

FIG. 1(b) is an exploded, perspective view of the traditional disk drive unit of FIG. 1(a);

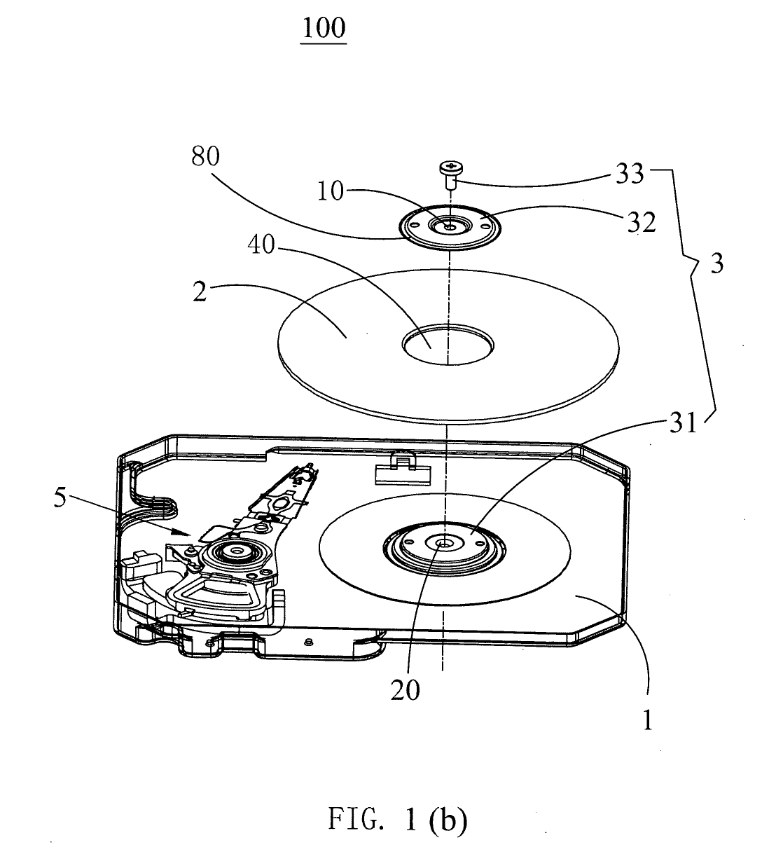

FIG. 2 is a cross-sectional view of the disk drive unit of FIG. 1(a) taken along line A-A;

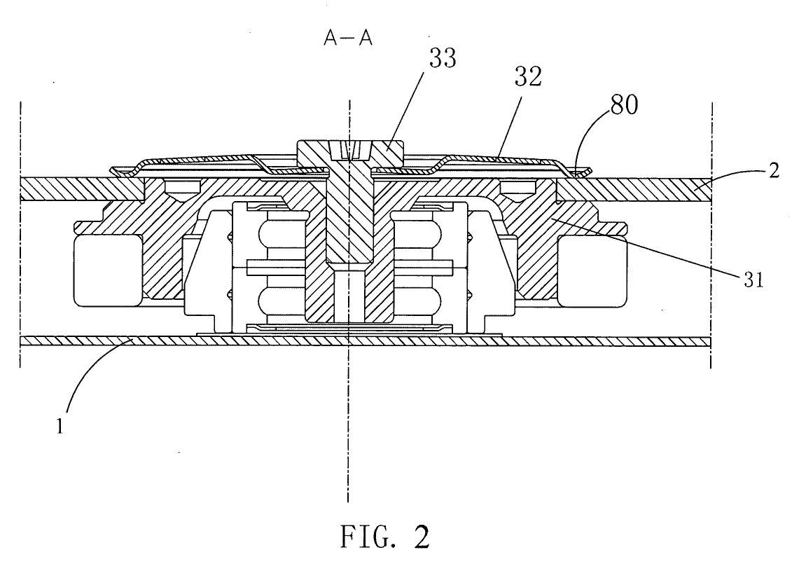

FIG. 3 is a perspective view of a disk drive unit according to an embodiment of the present invention;

FIG. 4A is an exploded, perspective view of the disk drive unit of FIG. 3;

FIG. 4B is a schematic view to show a process of dispensing adhesive on an inner diameter of the magnetic disk for gluing;

FIG. 5 is a cross-sectional view of the disk drive unit of FIG. 3 taken along line B-B according to a first embodiment of the invention; and

FIG. 5(b) is a cross-sectional view of the disk drive unit of FIG. 3 taken along line B-B according to a second embodiment of the invention.

### DETAILED DESCRIPTION OF THE INVENTION

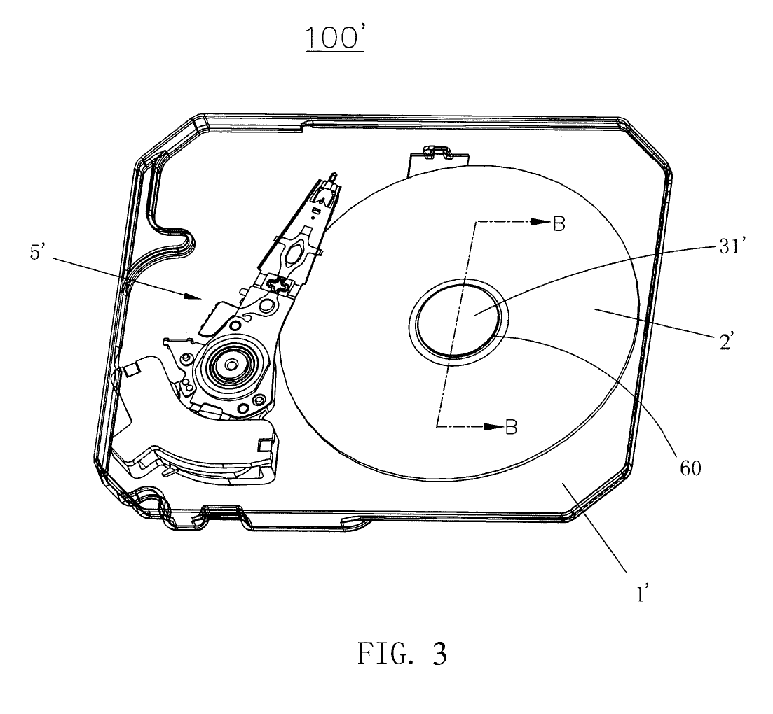

Referring now to the drawings in detail, FIG. 3 shows a disk drive unit 100′ according to an embodiment of the present invention. The disk drive unit 100′ comprises a motor base assembly 1′, a head stack assembly (HSA) 5′ with a slider (not shown), a magnetic disk 2′, and a spindle motor 31′ (hub) to cause the magnetic disk 2′ to spin. In the present invention, the slider can read data from or write data to concentric data tracks on the magnetic disk 2′.

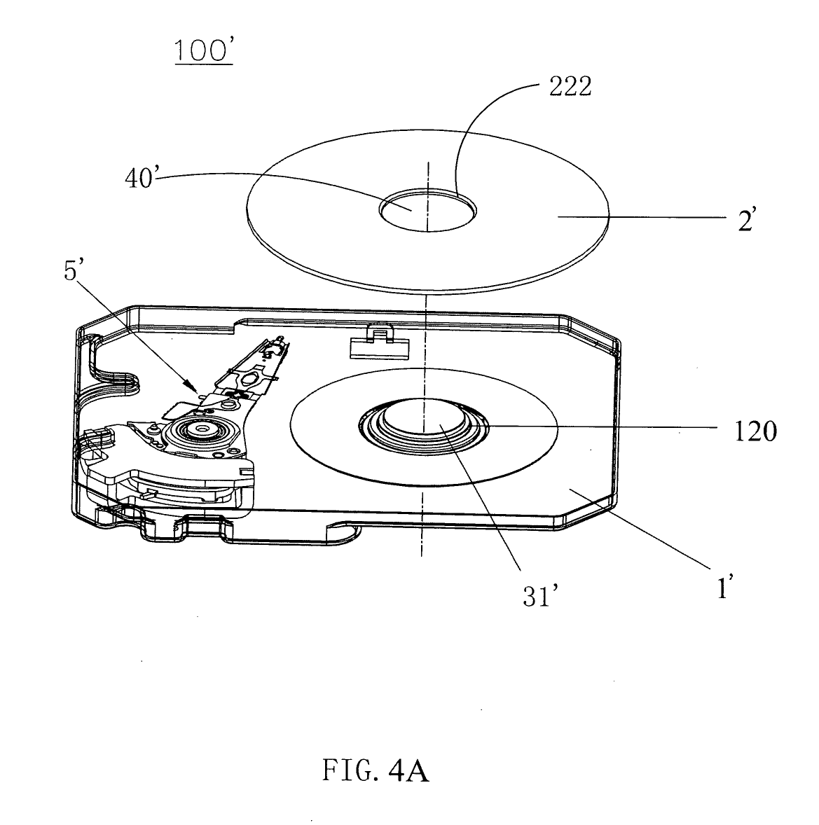

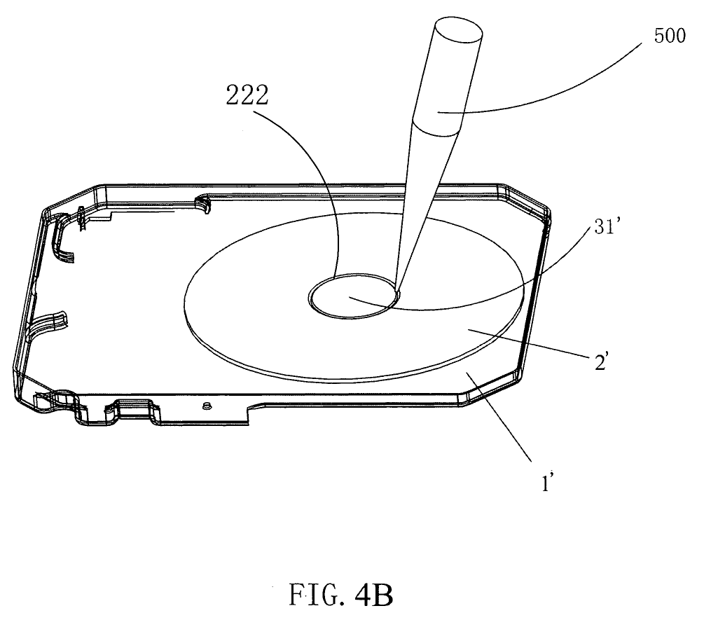

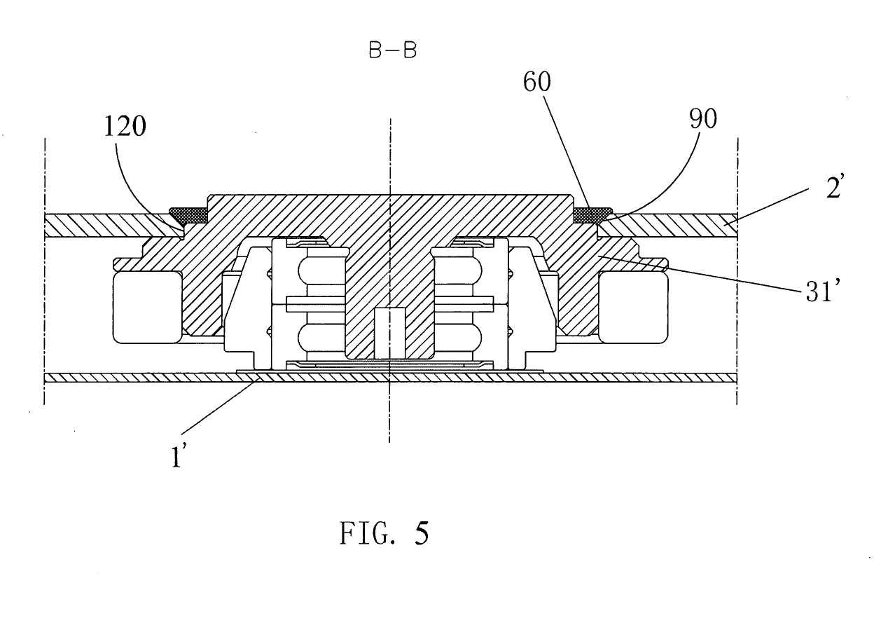

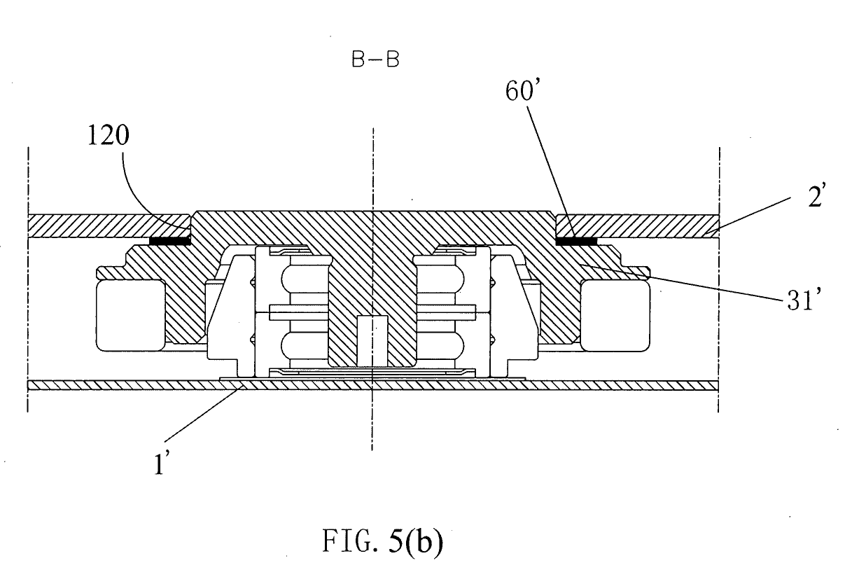

Referring to FIG. 4A, the hub 31′is mounted on the motor base assembly 1′. The magnetic disk 2′ having a central hole 40′ is positioned on the hub 31′ with the hub 31′ extending through the central hole 40′. Then, referring to FIG. 4B, an inner diameter 222 of the magnetic disk 2′ is dispensed with an adhesive through an adhesive dispenser 500. In the present invention, the adhesive can be thermoset resin or light curing resin or pressure sensitive adhesive. As an embodiment of the present invention, the adhesive is preferably epoxy glue. When the adhesive is dried, the magnetic disk 2′ is bonded with the hub 31′. As an embodiment of the present invention, the adhesive forms an adhesive part 60 (see FIG. 5) interposed between the magnetic disk 2′ and the hub 31′.

Also referring to FIGS. 4A and 5, a plurality of concentric annular steps 120 is formed on the circumference of the hub 31′. According to a first embodiment of the invention, a means for enlarging contact area of the magnetic disk 2′ with the adhesive is provided on the magnetic disk 2′. The setting of the means can attain a firm bonding between the magnetic disk 2′ and the hub 31′ because of a larger contact area. In an embodiment, the means is preferable a taper 90 formed on the inner diameter 222 of the magnetic disk 2′. This configuration of the magnetic disk 2′ not only makes the adhesive part 60 have a larger contacting area with the magnetic disk 2′, but also exerts a press force thereon so as to firmly fix the magnetic disk 2′ to the hub 31′.

Referring to FIG. 5(b), according to a second embodiment of the invention, the adhesive may be dispensed to a connection area between the hub 31′ and the magnetic disk 2′ and then forms an adhesive part 60′. The connection area is parallel to the surface of the magnetic disk 2′, which is different to the first embodiment shown in FIG. 5. In fact, because the connection area is parallel to the surface of the magnetic disk 2′, the contacting area between the adhesive and the magnetic disk 2′ is larger than that of the first embodiment so as to bond the hub 31′ with the magnetic disk 2′ firmly. Obviously, in order to attain a firm bonding between the hub 31′ and the magnetic disk 2′, the adhesive also can be dispensed to both the inner diameter 222 of the magnetic disk 2′ and the connection area parallel to the surface of the magnetic disk 2′.

In the present invention, manufacturing the disk drive unit 100′ comprises the steps of: providing a hub 31′ (spindle motor); providing a magnetic disk 2′ on a predetermined position; and dispensing an adhesive on a connection portion between the magnetic disk 2′ and the hub 31′. In the present invention, the adhesive is thermoset resin or light curing resin or pressure sensitive adhesive. In an embodiment, the method further comprises a step of forming a taper 90 on the connection portion of the magnetic disk 2′. In the present invention, the connection portion is the inner diameter 222 of the magnetic disk 2′ and/or the connection area parallel to the surface of the magnetic disk 2′. In a further embodiment, the adhesive can be a solid adhesive. In an embodiment, the solid adhesive can be made of thermoset resin or light curing resin or pressure sensitive adhesive. Accordingly, the method of manufacturing a disk drive unit comprises the steps of: providing a hub 31′; providing a magnetic disk 2′ on a predetermined position; and providing the solid adhesive to a connecting portion between the magnetic disk 2′ and the hub 31′. After providing the solid adhesive to the connecting portion between the magnetic disk 2′ and the hub 31′, the method may further comprise a step of curing the solid adhesive for a firm bonding between the magnetic disk 2′ and the hub 31′. In the embodiment, because using the solid adhesive to bond the magnetic disk 2′ and the hub 31′, the present invention not only makes the bonding process easier than that of using a liquid adhesive, but also avoids contaminating the components of the disk drive unit 100′. Obviously, it also lowers the manufacture cost of the disk drive unit 100′.

Because the present invention utilizes the adhesive to fix the magnetic disk 2′ on the hub (spindle motor) 31′ instead of using the traditional clamp and the screw so as to reduce the thickness of the disk drive unit 100′ in Z direction. Thus, the magnetic disk 2′ is easily concentric with the hub 31′. Also, it lowers the cost of manufacturing the disk drive unit for no additional clamp and screw need to be manufactured.

In addition, the adhesive part 60 occupies little, or no disk data zone comparing with the traditional clamp, so it may provide more data tracks on the magnetic disk 2′ to increase the data capacity thereof. In addition, because the adhesive part 60 made of the adhesive is rather flexible, so the magnetic disk 2′ gets a better disk flatness and a better uniformity of the pressing force in axial direction exerted to the inside diameter area of the magnetic disk 2′.

It is understood that the invention may be embodied in other forms without departing from the spirit thereof. Thus, the present example and embodiment are to be considered in all respects as illustrative and not restrictive, and the invention is not to be limited to the details given herein.

1. A disk drive unit comprises:
a disk;
a spindle motor; and
an adhesive for fixing the disk to the spindle motor.

2. The disk drive unit according to claim 1, wherein the adhesive is disposed on a connecting portion between the spindle motor and the disk.

3. The disk drive unit according to claim 1, wherein the adhesive is thermoset resin or light curing resin or pressure sensitive adhesive.

4. The disk drive unit according to claim 1, wherein the adhesive is epoxy glue.

5. The disk drive unit according to claim 1, wherein the disk has a means for enlarging contact area of the disk with the adhesive.

6. The disk drive unit according to claim 1, further comprising a taper formed on the connection portion of the disk.

7. A method of manufacturing a disk drive unit, comprises the steps of:
providing a spindle motor;
providing a disk on a predetermined position; and
dispensing an adhesive to a connection portion between the disk and the spindle motor.

8. The disk drive unit according to claim 7, wherein the adhesive is thermoset resin or light curing resin or pressure sensitive adhesive.

9. The method as claimed in claim 7, further comprising a step of forming a taper on the connecting portion of the disk.

10. A method of manufacturing a disk drive unit, comprises the steps of:
providing a spindle motor;
providing a disk on a predetermined position; and
providing a solid adhesive to a connecting portion between the disk and spindle motor.

11. The method as claimed in claim 10, further comprising a step of curing the solid adhesive.

12. The method as claimed in claim 10, wherein the adhesive is thermoset resin or light curing resin or pressure sensitive adhesive.

13. The method as claimed in claim 10, further comprising a step of forming a taper on the connecting portion of the disk.
